(19) United States
(12) Patent Application Publication
(10) Pub. No.: US 2026/0338251 A1
(43) Pub. Date: Oct. 29, 2026

(54) DAMPING VALVE DEVICE FOR A SHOCK ABSORBER OF A MOTOR VEHICLE

(71) Applicants: thyssenkrupp Bilstein GmbH, Ennepetal (DE); thyssenkrupp AG, Essen (DE)

(72) Inventors: Christoph SCHMIDT, Bonn (DE); Matthias HUNDT, Lennestadt (DE); Karim Mohamed EL KHAWAGA, Koeln (DE); Lennart Max FRICKE, Duesseldorf (DE)

(73) Assignees: thyssenkrupp Bilstein GmbH, Ennepetal (DE); thyssenkrupp AG, Essen (DE)

(21) Appl. No.: 19/655,158

(22) Filed: Apr. 22, 2026

(30) Foreign Application Priority Data
Apr. 23, 2025 (DE) 10 2025 115 717.0

(51) Int. Cl. F16F 9/46; B60G 13/08; B60G 17/08; F16F 9/18; F16F 9/348; F16K 31/40

(52) U.S. Cl. CPC F16F 9/464; F16F 9/185; F16F 9/3488; F16F 9/465; F16K 31/406; B60G 13/08; B60G 17/08; B60G 2202/24; B60G 2204/62; B60G 2206/41; B60G 2500/104; B60G 2500/11; B60G 2800/162; B60G 2800/916; F16F 2222/12; F16F 2228/066; F16F 2228/08; F16F 2230/18; F16F 2230/30; F16F 2232/08; F16F 2234/02

(57) ABSTRACT

A damping valve device for a vibration damper of a motor vehicle comprises a coil, an axially movable armature which is at least partially disposed within the coil, and a main valve with a main piston which mutually separates a main control chamber and a pilot control chamber, wherein the main control chamber and the pilot control chamber are fluidically connected to one another via a flow passage, wherein the damping valve device has a spring element which is disposed and designed in such a manner that it impinges the main piston with a force acting in the closing direction of the main valve, wherein the damping valve device has a sealing element which is designed and disposed in such a manner that it seals the main piston in relation to housing part of the main valve, wherein the damping valve device has a pre-load element which is designed and disposed in such a manner that it impinges the sealing element with a force acting in the axial direction of the damping valve device.

### CROSS REFERENCE TO RELATED APPLICATION

This application is a U.S. Non-Provisional that claims priority to German Patent Application No. DE 10 2025 115 717.0, filed Apr. 23, 2025, the entire content of which is incorporated herein by reference.

### FIELD

The present disclosure relates to a damping valve device for a shock absorber for motor vehicles, wherein the damping valve device has a main valve and a pilot valve.

### BACKGROUND

Known from DE 10 2020 215 480 A1 is a vibration damper with a damping valve device, wherein the damping valve device has a main valve and a pilot valve which is adjustable via a solenoid. Leakages which allow hydraulic fluid to flow from the pilot control chamber into the low-pressure chamber often occur in particular in the pilot control chamber of the main valve. Sealing assemblies of the pilot control chamber are already known from the prior art, but they are very complex to produce and assemble and thus cost-intensive. Furthermore, in the case of known seals, the requirements set for the sealing performance are not always met, in particular in the case of variable operating stages of the vibration damper, whereby known seals moreover often are subject to failure due to wear.

Thus a need exists to provide a damping valve device for a vibration damper, which has reliable sealing, in particular of the hydraulic chambers of the main valve and the pilot valve, and is able to be produced and assembled cost-effectively.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper in a longitudinal sectional view, according to an exemplary embodiment.

FIG. 2 shows a schematic illustration of a damping valve device in a longitudinal sectional illustration, according to a further exemplary embodiment.

FIG. 3 shows a schematic illustration of a detail of the damping valve device in a longitudinal sectional illustration, according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art

A damping valve device for a vibration damper of a motor vehicle comprises, according to a first aspect, a main valve with a main piston which mutually separates a main control chamber and a pilot control chamber. The main control chamber and the pilot control chamber are fluidically connected to one another via a flow passage. The damping valve device has a spring element which is disposed and designed in such a manner that it impinges the main piston with a force acting in the closure direction of the main valve. The damping valve device also has a sealing element which is designed and disposed in such a manner that it seals the main piston in relation to a housing part of the main valve. Furthermore, the damping valve device has a pre-load element which is designed and disposed in such a manner that it impinges the sealing element with a force acting in the axial direction of the damping valve device.

Such a pre-load element disposed in addition to the spring element allows axial pre-loading of the sealing element without affecting the closing force exerted on the main piston by means of the spring element. For example, a wear-related change in the geometry of the sealing element has, if at all, only a negligible effect on the spring element resting on the main piston.

The damping valve device is, for example, a pressure relief valve which can preferably be directly controlled or pilot-controlled. The main valve with the main piston is preferably designed for closing and opening the damping valve device, in particular the pressure relief valve. The main piston is preferably axially movable by means of the armature and/or the hydraulic pressure prevalent in the pilot control chamber.

A damping valve device designed as a pilot-controlled pressure relief valve preferably comprises, in addition to the main valve, a pilot valve with a pilot working chamber and a sliding tappet which is disposed in the pilot working chamber and is movable axially by means of the armature, and a connecting duct which is disposed between the pilot control chamber and the pilot working chamber and fluidically connects these to one another. For example, a valve spring element, in particular a valve washer pack with a plurality of spring washers, is attached to the main piston. In the closed position of the main valve, the main piston or, optionally, the valve spring element rests in a fluid-tight manner on the main valve seat.

For example, the pilot valve has a valve seat on which the sliding tappet rests in a closed position of the pilot valve in such a way that the connecting duct through the sliding tappet is closed in a fluid-tight manner.

According to the findings of the inventors, leakage occurs between the housing part and the main piston, so that an optimally positioned sealing element between these components reliably prevents a leakage flow between the pilot control chamber and the valve outlet.

The main piston is preferably movable relative to the housing part in the axial direction of the damping valve device. In particular, the sealing element is attached so as to be movable relative to the main piston and/or the housing part. For example, the sealing element is disposed between the inside of the housing part and the outside of the main piston. In particular, the sealing element rests on the radially outward facing outer surface of the main piston and the radially inward facing inner surface of the housing part. The sealing element preferably extends in a radial direction between the main piston and the housing part. Preferably, the main piston and the housing part have a mutual radial spacing, wherein the sealing element is attached within the radial spacing. The sealing element is preferably designed to be annular, in particular annular-shaped. For example, the sealing element has a quadrangular, triangular, in particular rectangular cross section. Modified geometries and cross sections such as polygonal, radiused corners can likewise be used. The sealing element is preferably designed as one part or integrally.

The damping valve device is disposed in a vibration damper for a motor vehicle, for example. The vibration damper is, for example, a monotube vibration damper or a multi-tube vibration damper, by way of example a twin-tube vibration damper. The vibration damper comprises, for example, an outer tube which forms an external surface, in particular a housing, of the vibration damper. An inner tube, which is also referred to as damper tube, is disposed within the outer tube so as to be coaxial with the latter. A compensation chamber, which is preferably at least partially filled with a hydraulic fluid, is formed between the outer tube and the inner tube. For example, the compensation chamber is partially filled with a gas.

A working piston which is connected to a piston rod is preferably disposed within the inner tube in such a manner that said working piston is movable within the inner tube, wherein the inner tube is preferably designed as a guide of the working piston. A damping valve device according to the invention is disposed on the working piston, for example. The working piston divides the interior of the inner tube, in particular, into a first, piston rod-proximal working chamber and a second, piston rod-distal working chamber.

For example, the damping valve device is disposed at least partially outside the outer tube of the vibration damper. In such an external arrangement of the damping valve device, a central tube is optionally disposed within the compensation chamber coaxially with and between the inner tube and the outer tube. For example, the damping valve device is attached to the central tube. The central tube is preferably attached in a fluid-tight manner to the inner tube, wherein an annular space is formed between the central tube and the inner tube. The central tube preferably has a flange region for attaching the damping valve device to the central tube, which preferably forms a fluid inlet and/or fluid outlet of the damping valve device. The outer tube preferably has an opening which is co-aligned with the flange region for receiving the damping valve device, so that the damping valve device is fluidically connected to the compensation chamber. For example, the vibration damper has a further damping valve device, which is also disposed, for example, outside the outer tube. Preferably, the further damping valve device is fluidically connected to the inner tube, in particular to the piston rod-distal working chamber, by means of an adapter attached within the inner tube. The damping valve devices are preferably of identical design.

The vibration damper preferably has a closure pack which fluidically seals the interior of the outer tube on the piston rod-proximal side. Opposite the closure package, at the piston rod-distal end, the interior of the outer tube is preferably fluidically sealed by means of a base piece. A base valve, which is attached to the piston rod-distal end of the inner tube, is in particular disposed on the base piece.

The damping valve device comprises a preferably cylindrical damping valve housing which has a substantially tubular tube part and a housing upper part which is attached to the tube part. By way of example, the housing upper part has a connection region which has one or a plurality of terminal contacts for an electrical current supply of the damping valve device. The terminal contacts for an electrical current supply are preferably connected to a drive unit. The housing upper part has, for example, a circular-cylinder-shaped cover portion adjoined by a hollow-cylindrical portion, the latter having a smaller diameter, for example.

The damping valve device preferably has a drive which is designed as a solenoid, in particular a coil having a plurality of windings made of a current-conducting wire. The coil is preferably disposed within a housing of the damping valve device and comprises, for example, a coil carrier on which the windings of the coil are wound. The coil preferably at least partially or completely encloses an armature chamber which extends centrally in the axial direction. An armature is preferably mounted so as to be axially movable within the armature chamber. The armature is preferably attached so as to be able to slide in the axial direction within the armature chamber and comprises, for example, a central armature rod which, by way of example, is of tubular design and extends centrally in the axial direction through the armature chamber. The armature chamber is preferably delimited by an at least partially hollow-cylindrical pole tube which preferably serves as a guide for the armature.

The damping valve device preferably comprises a main valve and optionally a pilot valve, and in particular a valve inlet for inducting hydraulic fluid into the damping valve device and a valve outlet for discharging hydraulic fluid from the damping valve device. The pilot valve is preferably disposed downstream of the main valve. In particular, a flow of hydraulic fluid is able to pass through the damping valve device in only one direction.

The main valve preferably comprises a main piston which is disposed so as to be axially movable within a main working chamber. The main valve comprises a housing part which at least partially delimits the main working chamber and forms an axial guide for the main piston. The main piston is preferably disposed in such a manner that it separates a main control chamber and a pilot control chamber from one another, wherein the main piston optionally has a flow passage, which extends through the main piston and forms a fluidic connection between the main control chamber and the pilot control chamber. Optionally, the pilot control chamber is fluidically connected to the first or second working chamber of the vibration damper by way of a flow passage. The housing part is, for example, designed in the shape of a hollow cylinder and comprises, for example, the valve inlet or the valve outlet. Preferably, the housing part encloses the main valve, in particular the main piston, the main working chamber with the main control chamber and the pilot control chamber at least partially or completely in the axial direction and/or in the circumferential direction.

For example, the main piston is designed in such a manner that the end face of the main piston that faces the main control chamber and is impinged with the hydraulic pressure of the main control chamber is larger than the end face of the main piston that faces the pilot control chamber and is impinged with the hydraulic pressure of the pilot control chamber.

In the operation of the damping valve device, in particular of a pilot-controlled or directly controlled pressure relief valve, the hydraulic fluid flows through the valve inlet into the main control chamber, wherein the pressure in the main control chamber of the main piston is impinged with an opening force and moved axially in the opening direction. The main piston and optionally the valve spring element are lifted from the main valve seat and the hydraulic fluid flows through the main flow passage to the valve outlet. At the same time, a sub-flow of the hydraulic fluid flows through the flow passage in the main piston to the pilot control chamber and impinges the main piston with a closing force acting in the direction of the main valve seat. The closing force determines the opening width of the main valve, in particular the cross section of the main flow duct, the latter determining the damping force of the damping valve device.

In the case of a pilot-controlled pressure relief valve, the closing force is preferably determined by the pressure prevalent in the pilot control chamber. The pressure in the pilot control chamber is in particular set by the pilot valve, wherein the hydraulic fluid flows from the pilot control chamber into the pilot working chamber by way of the connecting duct which is released by the sliding tappet. The opening width of the connecting duct depends on the axial position of the sliding tappet, which is set, in particular predefined, by means of a solenoid.

In a directly controlled pressure relief valve, the closing force of the main piston is preferably determined by the pressure prevalent in the pilot control chamber and/or by means of the solenoid. For example, the main piston is directly connected to the armature in such a way that the armature impinges the main piston with a force acting in the axial direction, in particular in the closing direction. The directly controlled pressure relief valve preferably does not have a pilot valve.

In an external damping valve device disposed outside the outer tube, the valve inlet is formed in particular in a flange region of the damping valve device, wherein the flange region is preferably connected to an outer tube, inner tube and/or central tube of the vibration damper. The main valve preferably has a main valve seat which is formed, for example, on the flange region and on which the main piston rests in a fluid-tight manner in the closed position of the main valve. In the open position of the main valve, in which the main piston is lifted from the main valve seat in the axial direction, a main flow duct between the main piston and the valve seat is preferably formed. The main flow duct preferably forms a fluidic connection between the valve inlet, in particular the main control chamber, and the valve outlet.

Attached to that side of the main piston that faces away from the valve seat is preferably the spring element which is disposed in such a manner that it impinges the main piston with a spring force acting in the direction of the main valve seat. The spring element is, for example, a pre-load spring with one or at least two spring washer packs, wherein the spring washer packs are preferably designed as a circular disc, in particular as a disc spring.

The damping valve device, in particular a pilot-controlled pressure relief valve, preferably comprises a connecting duct for connecting the pilot control chamber to a pilot working chamber of the pilot valve. The connecting duct is preferably formed in a housing part, or a region that is connected in a positionally fixed manner to the housing of the damping valve device, and extends in particular centrally and in the axial direction. Preferably, the connecting duct forms the fluid inlet into the pilot valve.

The pilot valve preferably comprises a sliding tappet which is disposed so as to be axially movable within the pilot working chamber. The sliding tappet by way of its end that faces away from the main valve preferably rests on the armature in such a way that the movement of the armature and of the sliding tappet are mechanically coupled at least in the rebound direction. The pilot valve is preferably movable to a closed position in which the sliding tappet rests on a first valve seat of the pilot valve in such a manner that the connecting duct is completely closed by the sliding tappet in such a way that preferably no flow of fluid is able to pass through the connecting duct into the pilot working chamber. The pilot valve is preferably movable to an open position in which the sliding tappet is lifted from the first valve seat of the pilot valve in such a way that the connecting duct is released by the sliding tappet and fluid flows between the pilot control chamber of the main valve and the pilot working chamber. For example, the pilot valve has a fluid duct for fluidically connecting the pilot working chamber to the valve outlet. The pilot working chamber is preferably fluidically connected to an outflow duct through which the hydraulic fluid is able to flow from the pilot working chamber into a valve outlet, in particular into the first or second working chamber.

According to a first embodiment, the pre-load element rests on the spring element. Preferably, the pre-load element is supported in the axial direction on the spring element.

According to a further embodiment, the spring element comprises at least one spring washer and one compensation ring, wherein the pre-load element rests on the compensation ring. The compensation ring is preferably annular-shaped and in particular made of a non-resilient, rigid material. In particular, the compensation ring is disposed so as to be movable relative to the housing part. The compensation ring preferably rests on the main piston and is disposed in particular between the main piston and the at least one spring washer of the spring element.

According to a further embodiment, the pre-load element comprises a pre-load spring. The pre-load spring is, for example, a spring washer, a disc spring or a helical spring. Preferably, the pre-load spring rests on the spring element, in particular on the compensation ring. In particular, the pre-load spring within the damping valve device is pre-loaded in the direction of the damping element.

According to a further embodiment, the pre-load element comprises a pre-load washer which is preferably disposed separately from the pre-load spring. The pre-load washer is in particular annular-shaped and has, for example, a annular diameter which corresponds approximately to the width of a clearance of the main piston.

According to another embodiment, the pre-load washer is disposed between the pre-load spring and the sealing element. According to another embodiment, the pre-load washer rests on the sealing element. Preferably, the pre-load washer rests on a lateral surface of the sealing element in such a manner that the former completely covers the latter.

According to a further embodiment, the pre-load washer rests on the main piston and/or a stationary housing part. Preferably, the pre-load washer extends completely over the width of the gap between the main piston and the housing part.

According to another embodiment, the pre-load spring rests on the compensation ring. Optionally, the pre-load spring rests directly on the sealing element, with no pre-load washer provided. It is likewise conceivable that the pre-load spring rests directly on one of the spring washers of the spring element, with no compensation ring provided.

According to a further embodiment, the sealing element is formed of a dimensionally stable, in particular non-elastic, material such as a PTFE or a plastics material. It is likewise conceivable that the sealing element is alternatively formed from an elastomer.

According to a further embodiment, a clearance is formed in the main piston and the sealing element is disposed within the clearance. The clearance preferably extends circumferentially and from the outer surface in the radial direction inwards. In particular, the clearance is formed on the end region of the main piston that faces in the direction of the spring element. The clearance is preferably disposed between the main piston and the housing part, wherein the sealing element is disposed within the clearance. For example, the clearance is formed so as to proceed from the spring element-proximal end of the main piston in the direction of the main control chamber through a portion with a constant external diameter of the main piston and a subsequent portion with a continuously enlarged external diameter of the main piston.

Preferably, the clearance is formed on a portion of the main piston with a continuously tapered external diameter, wherein the sealing element rests at least partially on the tapered portion of the main piston. The sealing element preferably rests at least partially on the portion of the main piston with an external diameter that changes continuously, in particular tapers in the direction of the pilot valve. The main piston preferably has a first portion with an external diameter that is constant in the axial direction and preferably rests on the internal diameter of the housing part. The spring element-proximal end portion of the main piston preferably has a second portion with an external diameter that is constant in the axial direction and is smaller than the external diameter of the first portion. Preferably formed directly between the first and the second portion is a portion with a continuously decreasing external diameter, the sealing element resting in particular thereon.

In the operation of the damping valve device, the pressure of the pilot control chamber is preferably prevalent on the region of the sealing element that points in the direction of the pilot valve, impinging the sealing element with a hydraulic force by way of which the latter is pre-loaded in such a manner, for example, that it rests flush on the main piston, in particular on the portion with the tapered external diameter, thus forming an optimal sealing assembly between the main piston and the tube part.

According to another embodiment, the sealing element is attached so as to be movable within the clearance. Preferably, the sealing element is movable relative to the main piston and/or housing part. In particular, the sealing element is disposed within the pilot control chamber of the main valve.

According to a further embodiment, the damping valve device comprises a coil and an axially movable armature which is at least partially disposed within the coil, a pilot valve with a pilot working chamber and a sliding tappet which is disposed in the pilot working chamber and is movable axially by means of the armature, and a connecting duct which is disposed between the pilot control chamber and the pilot working chamber and fluidically connects these to one another.

According to a further embodiment, the damping valve device comprises a coil and an axially movable armature which is at least partially disposed within the coil, wherein the armature is connected to the main piston in such a way that the former impinges the latter with a closing force.

The invention also comprises a vibration damper with a damping valve device described above, wherein the damping valve device is disposed, for example, on the working piston and/or at least partially outside the outer tube.

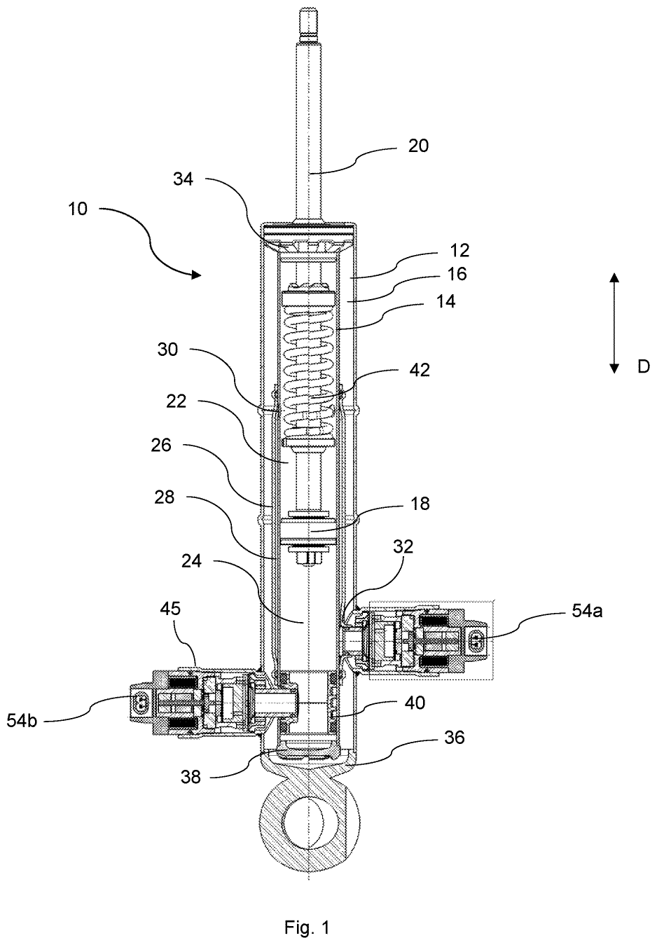

FIG. 1 shows a vibration damper 10, wherein the vibration damper 10 is a multi-tube vibration damper, by way of example a twin-tube vibration damper. The vibration damper 10 has an outer tube 12 which forms an outer surface, in particular a housing, of the vibration damper 10. An inner tube 14, which can also be referred to as a damper tube, is disposed within the outer tube 12 so as to be coaxial with the latter. Formed between the outer tube 12 and the inner tube 14 is a compensation chamber 16 which is preferably at least partially filled with a hydraulic fluid. For example, the compensation chamber 16 is partially filled with a gas.

A working piston 18, which is connected to a piston rod 20, is disposed within the inner tube 14 in such a manner that said working piston is movable within the inner tube 14, wherein the inner tube is preferably designed as a guide of the working piston 18. The working piston 18 has, for example, a valve device not illustrated. The working piston 18 divides the interior of the inner tube 14 into a first working chamber 22, which is disposed proximal to the piston rod, and a second working chamber 24, which is disposed distal from the piston rod. A central tube 26 is disposed in the compensation chamber 16 so as to be coaxial with and between the inner tube 14 and the outer tube 12.

Proximal to the piston rod, the interior of the outer tube 12 is fluidically sealed by means of a closure pack 34. Opposite the closure pack 34, at the piston rod-distal end, the interior of the outer tube 12 is fluidically sealed by means of a base piece 36. By way of example, a base valve 38, which is attached in particular to the piston rod-distal end of the inner tube 14, is disposed on the base piece 36. The base valve 38 is, for example, a check valve which is able to be passed through by a flow in both directions or only one direction. The second working chamber 24 is preferably fluidically connected to the compensation chamber 16 via the base valve 38. The piston rod-proximal end of the inner tube 14 and of the outer tube 12 is preferably fastened to the closure package 34.

The central tube 26 is preferably attached in a fluid-tight manner to the inner tube 14. An annular space 28 is formed between the central tube and the inner tube 14. Formed in the inner tube 14 is at least one passage opening 30 which fluidically connects the first working chamber 22 to the annular space 28.

By way of example, the central tube 26 has a flange region 32 for attaching a damping valve device 54a to the central tube 26. The flange region 32 forms a receptacle for the damping valve device 54a, in particular the flange region 32 forms a fluid inlet and/or fluid outlet of the damping valve device 54a. The flange region 32 connects, for example, the annular chamber 28 to the damping valve device 54a. The outer tube 12 preferably has an opening for receiving the damping valve device 54a, which is co-aligned with the flange portion 32 in such a way that the damping valve device 54a is fluidically connected to the compensation chamber 16.

By way of example, the vibration damper 10 comprises a further damping valve device 54b, which is fluidically connected to the inner tube 14, in particular to the piston rod-distal working chamber 24, by means of an adapter 40 attached within the inner tube 14. Preferably, the outer tube 12 and the central tube 26 have openings, which are co-aligned with the adapter, for receiving the damping valve device 54a. By way of example, the damping valve devices 54a, b are of identical design. For example, the damping valve devices 54a, b are designed as directly controlled or pilot-controlled pressure relief valves.

By way of example, the piston rod 20 has an optional rebound stop which is loaded with a spring force via a spring element 42 in the case of a movement in the rebound direction Z.

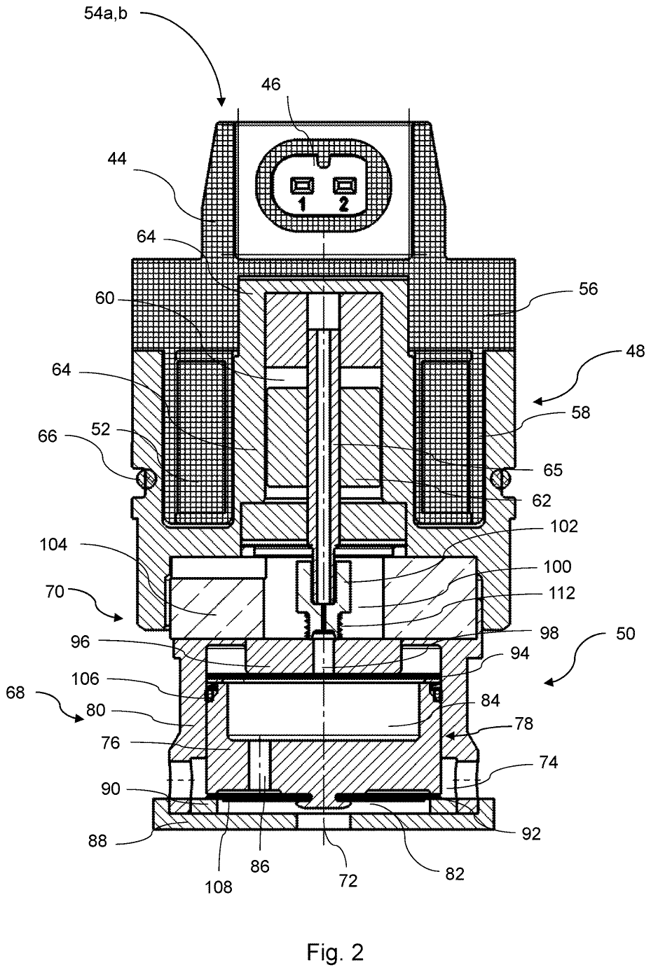

FIG. 2 shows an exemplary damping valve device 54a, b, which is preferably disposed as an external valve at least partially outside the outer tube 12 of the vibration damper 10. By way of example, the damping valve device 54a, b is designed as a pilot-controlled pressure relief valve and comprises a preferably cylindrical damping valve housing which has a substantially tubular tube part 45, illustrated in FIG. 1, and a housing upper part 44 attached to the tube part 45. By way of example, the housing upper part 44 has a connection region 46 which has one or a plurality of terminal contacts for an electrical current supply of the damping valve device 54a, b. The terminal contacts for an electrical current supply are preferably connected to a drive unit. By way of example, the housing upper part 44 has a circular-cylindrical cover portion 56 adjoined by a hollow-cylindrical portion 58 which has a smaller diameter, for example.

By way of example, the damping valve device 54a, b has a drive region 48 and a valve region 50. By way of example, the drive region 48 is disposed in the upper region of the damping valve device 54a, b that faces the housing upper part 44 and is preferably disposed so as to be substantially above the valve region 50. The drive region 48 preferably comprises a drive in the form of a solenoid. The solenoid comprises a coil 52 having a plurality of windings made of a current-conducting wire. The coil 52 is preferably disposed within the tube part 45 and so as to be concentric with the latter. By way of example, the coil 52 is disposed within the hollow cylinder portion 58 of the housing upper part 44 and lies in particular against the inner wall of the housing upper part 44. For example, the housing upper part 44 is formed from a plastics material, in particular a non-magnetic or only very slightly magnetic material, preferably a magnetic isolator, or a material with a high magnetic resistance. The coil 52 comprises, for example, a coil carrier on which the windings of the coil are wound. The coil 52 encloses at least partially or completely an armature chamber 60 which extends centrally in the axial direction. An armature 62 is mounted so as to be axially movable within the armature chamber 60. The armature 62 is preferably of cylindrical design and has a diameter which is slightly smaller than the diameter of the armature chamber 60, such that the armature 62 is preferably attached so as to be able to slide in the axial direction. By way of example, the armature 62 comprises a central armature rod 65 which, by way of example, is of a tubular design and extends centrally in the axial direction through the armature chamber 60. The armature chamber 60 is preferably delimited by an at least partially hollow-cylindrical pole tube 64. The pole tube 64 preferably has a base and is designed to be open, in particular, in the direction of the valve region 50. The pole tube 64 is preferably made of a magnetizable or magnetic material and has, for example, a magnetic separation not illustrated.

The coil 52 is preferably designed and disposed in such a manner that, when energized, it forms a magnetic field which has magnetic field lines that preferably run substantially in the axial direction in the armature chamber 60. The armature 62 is preferably formed from a magnetizable or magnetic material and movable in the axial direction, in a manner corresponding to the polarity of the magnetic field formed by means of the coil 52.

The hollow-cylindrical region of the pole tube 64 is adjoined in the axial direction and coaxially therewith by a pole tube element, wherein the hollow-cylindrical region and the pole tube element conjointly form the pole tube 64, wherein the pole tube 64 is in particular formed in multiple parts, one part or integrally. The pole tube 64 has an upper tubular region with an, in particular, constant internal diameter which is preferably formed as a hollow cylinder and extends from the housing upper part 44 in the axial direction as far as beyond the armature 62. The upper hollow-cylindrical region is adjoined in the axial direction by a lower region with an enlarged diameter, wherein the external surface of the pole tube 64 preferably extends as far as the tube part 45, illustrated in FIG. 1, and at least partially rests on the latter and is sealed in a fluid-tight manner in relation to the tube part 45 by way of a sealing element 66. The tube part 64 encloses at least partially a valve region 50 which will be explained in more detail in one of the following paragraphs.

The valve region 50 comprises, by way of example, a main valve 68 and a pilot valve 70 as well as a valve inlet 72 for admitting hydraulic fluid into the damping valve device 54a,b and a valve outlet 74 for discharging hydraulic fluid from the damping valve device 54a, b. In the operation of the damping valve, the hydraulic fluid, in particular the pilot flow, preferably flows from the valve inlet 72 into the main valve 68, then into the pilot valve 70 and subsequently to the valve outlet 74. The main valve 68 comprises a main piston 76 which is disposed so as to be axially movable within a main working chamber 78. By way of example, the main valve 68 also comprises a housing part 80 which at least partially delimits the main working chamber 78 and forms an axial guide for the main piston 76. The main piston 76 is preferably disposed within the housing part 80, so as to be concentric with the latter. The main piston 76 preferably divides the main working chamber 78 into a main control chamber 82 and a pilot control chamber 84, wherein the main piston 76 in particular has a flow passage 86 that extends through the main piston 76 and forms a fluidic connection between the main control chamber 82 and the pilot control chamber 84.

The valve inlet 72 is formed in particular in a flange region 88 of the damping valve device 54a, b, wherein the flange region 88 is preferably connectable to an outer tube 12, inner tube 14 and/or central tube 26 of the vibration damper 10. By way of example and optionally, a valve spring element 108, in particular a valve washer pack with a plurality of spring washers, is attached to the main piston 76. The valve spring element 108 is preferably annular-shaped and attached to a central shoulder of the main piston 76. Formed on the flange region 88 is a main valve seat 90 on which the main piston 76 or the valve spring element 108 rests in a fluid-tight manner in the closed position of the main valve 68. In the opened position of the main valve 68, in which the main piston 76, and optionally the valve spring element 108, is moved away from the main valve seat 90 in the axial direction, the main piston 76, or optionally the valve spring element 108, is lifted from the main valve seat 90 in such a way that a main flow duct 92 is formed between the main piston 76, or the valve spring element 108, and the main valve seat 90. Preferably, the valve spring element 108 rests on the valve seat 90 between the latter and the main piston 76. In particular, the valve spring element 108 has a passage for admitting hydraulic fluid into the flow passage 86. The main flow duct 92 forms a fluidic connection between the valve inlet 72, in particular the main control chamber 82, and the valve outlet 74.

The main piston 76 has on its face pointing in the direction of the drive region 48 an in particular central clearance, so that the main piston 76 has a hollow-cylindrical region. The clearance of the main piston 76, in particular the interior of the hollow cylindrical region, preferably delimits the pilot control chamber 84 at least partially. Attached to that side of the main piston 76 that faces away from the main valve seat 90 is a spring element 94 which is disposed in such a manner that it impinges the main piston 76 with a spring force acting in the direction of the valve seat 90. The spring element 94 is, for example, a pre-load spring with at least one or two spring washers, wherein the spring washers are preferably annular-shaped, in particular formed as disc springs. The spring element 94 preferably extends over the entire diameter, or part thereof, of the pilot control chamber 84, in particular to the inner wall of the housing part 80.

The spring element 94 preferably rests on a central block 96 which is connected in a positionally fixed manner to the housing part 80. By way of example, the central block 96 is disposed in the pilot control chamber 84 and is supported on the housing part 80, or is fixedly connected to the latter or is formed in one piece or integrally with the latter. A connecting duct 98 for connecting the pilot control chamber 84 to a pilot working chamber 100 of the pilot valve 70 is preferably formed in the central block 96. The connecting duct 98 preferably extends centrally and in the axial direction through the central block 96. Preferably, the connecting duct 98 forms the fluid inlet into the pilot valve 70. The spring element 94 is preferably designed and disposed in such a manner that it has a fluid passage for admitting fluid into the connecting duct 98. Preferably, the spring element comprises a central opening which is disposed so as to be co-aligned with the connecting duct 98.

By way of example, the pilot valve 70 comprises a sliding tappet 102 which is disposed so as to be axially movable within the pilot working chamber 100. The sliding tappet 102 by way of its end that faces away from the main valve 68 preferably rests on the armature 62 in such a way that the movement of the armature 62 and of the sliding tappet 102 are coupled at least during the movement of the armature 62 in the direction of the sliding tappet 102. In a closed position of the pilot valve 70, the sliding tappet 102 preferably rests on the central block 96 in such a way that the connecting duct 98 is completely closed by the sliding tappet 102. In an opened position of the pilot valve 70, the sliding tappet 102 is lifted from the central block 96, such that the connecting duct 98 is opened by the sliding tappet 102 and a fluid flows between the pilot control chamber 84 of the main valve 68 and the pilot working chamber 100. The pilot valve 70 preferably has a pilot housing part 104 which is disposed in a positionally fixed manner and, by way of example, rests on the housing part 80 or is fixedly connected thereto. The pilot working chamber 100 is formed within the pilot housing part 104. By way of example, the sliding tappet 102 has a U-shaped longitudinal section. Preferably, the sliding tappet 102 is fixedly connected to the armature rod 65, in particular in a force-fitting, form-fitting or materially integral manner, preferably screwed to the latter. The sliding tappet 102 preferably has an axial contact surface which points in the direction of the connecting duct 98 and on which a pilot spring element 112 rests. The pilot spring element 112 is, for example, a helical spring and is in particular designed and disposed to impinge the sliding tappet 102 with a force pointing in the direction of the drive region 48, i.e. in the opening direction of the pilot valve 70.

FIG. 2 shows the pilot valve 70 which by way of example is shown in a closed position, wherein the sliding tappet 102 completely closes the connecting duct. In the closed position, the sliding tappet 102 preferably rests on a valve seat which is formed in the central block 96.

In the operation of the damping valve device 54a, b, the hydraulic fluid flows through the valve inlet 72 into the main control chamber 82, wherein, as a result of the pressure in the main control chamber 82, the main piston 76 is impinged with an opening force and moved axially upwards. In the process, the main piston 76 and, by way of example, the valve spring element 108 are lifted from the main valve seat 90, and the hydraulic fluid flows through the main flow duct 92 to the valve outlet 74. At the same time, a sub-flow of the hydraulic fluid flows through the flow passage 86 in the main piston 76 to the pilot control chamber 84 and impinges the main piston with a closing force acting in the direction of the main valve seat 90. The closing force determines the opening width of the main valve 68, in particular the cross section of the main flow duct 92, which determines the damping force of the damping valve device 54a, b. The pressure in the pilot control chamber 84 is set by the pilot valve 70, wherein the hydraulic fluid flows from the pilot control chamber 84 through the connecting duct 98 into the pilot working chamber 100, the latter being released by the sliding tappet 102. The opening width of the connecting duct 98 depends on the axial position of the sliding tappet 102, which is set, in particular predefined, by means of a solenoid 54. In the closed position of the pilot valve 70, the sliding tappet 102 preferably closes the connecting duct 98 completely in such a way that the hydraulic pressure in the pilot control chamber 84 increases to a maximum value and the main valve 68 is closed due to the main piston 76 being pressed onto the main valve seat 90. In an opened position of the pilot valve 70, the connecting duct 98 is at least partially released by the sliding tappet 102, so that there is a hydraulic flow into the flow duct to the valve outlet 74.

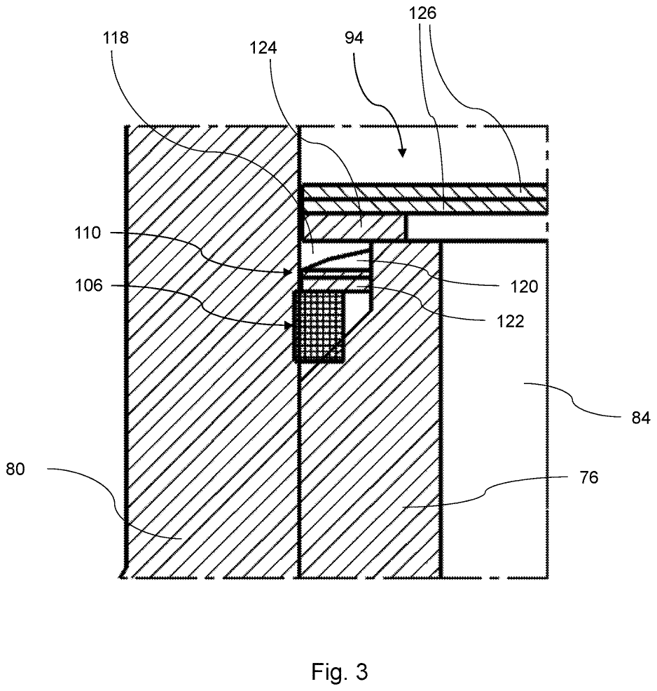

FIG. 3 shows a detail of the damping valve device 54a, b of FIG. 2, identical elements being provided with the same reference signs. The damping valve device 54a, b, has a sealing element 106 which is designed and disposed in such a way that it seals the main piston 76 in a fluid-tight manner in relation to the housing part 80 of the main valve 68. The sealing element 106 is preferably annular, in particular doughnut-shaped.

By way of example, the sealing element 106 by way of a lateral surface rests on the housing part 80. The housing part 80 is preferably attached so as to be stationary within the damping valve device 54a, b, wherein the main piston 76 is attached so as to be movable relative to the housing part 80. The sealing element 106 by way of a further, in particular opposite, lateral surface preferably rests on the main piston 76. Preferably, the sealing element 106 by way of its lateral surface opposite the housing part 80 likewise rests at least partially on the main piston 76. The sealing element 106 is preferably formed in one piece or integrally. The sealing element 106 is preferably formed from an elastically non-deformable material.

By way of example, the main piston 76 has a clearance 118. The clearance 118 preferably extends circumferentially and from the outer surface in the radial direction inwards. In particular, the clearance 118 is formed on the end region of the main piston 76 that points in the direction of the spring element 94. The clearance 118 is disposed between the main piston 76 and the housing part 80, wherein the sealing element 106 is disposed within the clearance 118. By way of example, the clearance 118 is formed so as to proceed from the spring element-proximal end of the main piston 76 in the direction of the main control chamber 82 through a portion with a constant external diameter of the main piston 76 and a subsequent portion with a continuously enlarged external diameter of the main piston 76.

The sealing element 106 preferably rests at least partially on the portion of the main piston 76 with a continuously changing external diameter, the latter in particular tapering in the direction of the pilot valve.

Preferably, the sealing element 106 is disposed in such a manner that it seals the pilot control chamber 84 in relation to the valve outlet 74. In the operation of the damping valve device 54a, b, the pressure of the pilot control chamber 84 is preferably prevalent on the region of the sealing element 106 that points in the direction of the pilot valve 70, impinging the sealing element 106 with a hydraulic force by way of which the latter is deformed in such a manner, for example, that it rests flush on the main piston, in particular on the portion with the tapered external diameter, thus forming an optimal sealing assembly between the main piston and the housing part 80.

By way of example, the damping valve device 54a, b has a pre-load element 110 which is designed and disposed in such a manner that it impinges the sealing element 106 with a force acting in the axial direction of the damping valve device. Preferably, the pre-load element 110 impinges the sealing element 106 with a force pointing in the axial direction of the main valve seat. The pre-load element 110 preferably comprises a pre-load spring 120 and a pre-load washer 122. The pre-load spring 120 is, for example, a spring washer, a disc spring or a helical spring. Preferably, the pre-load washer 122 is disposed between the pre-load spring 120 and the sealing element 106. The pre-load washer 122 preferably rests directly on the sealing element 106 and in particular directly on the pre-load spring 120.

The pre-load washer 122 is in particular annular-shaped and has a annular diameter which corresponds approximately to the width of the clearance 118. Preferably, the pre-load washer 122 extends completely over the width of the clearance 118 and in particular by way of its external circumference rests on the inner surface of the housing part 80, and by way of its internal circumference rests on the outer surface of the main piston 76. Preferably, the pre-load washer 122 rests on a lateral surface of the sealing element 106. The lateral surface of the sealing element 106 that points upwards, i.e. in the direction of the pilot valve 70, is in particular covered at least partially or completely by the pre-load washer 122.

The spring element 94 preferably comprises a plurality of spring washers 126 and a compensation ring 124, the latter resting on a spring washer 126. The compensation ring 124 preferably rests on the main piston 76 and is disposed in particular between the main piston 76 and the at least one spring washer 126 of the spring element 94. The pre-load element 110 rests in particular on the spring element 94, preferably on the compensation ring 124. Preferably, the pre-load spring 120 rests on the spring element 94, in particular on the compensation ring 124.

### LIST OF REFERENCE SIGNS

10 Vibration damper
12 Outer tube
14 Inner tube
16 Compensation chamber
18 Working piston
20 Piston rod
22 First/piston rod-proximal working chamber
24 Second/piston rod-distal working chamber
26 Central tube
28 Annular space
30 Passage opening
32 Flange region
34 Closure pack
36 Base piece
38 Bottom valve
40 Adapter
42 Spring element
44 Housing upper part
45 Tube part
46 Connection region
48 Drive region
50 Valve region
52 Coil
54a, b Damping valve device
56 Cover portion
58 Hollow-cylindrical portion
60 Armature chamber
62 Armature
64 Pole tube
65 Armature rod
66 Sealing element
68 Main valve
70 Pilot valve
72 Valve inlet
74 Valve outlet
76 Main piston
78 Main working chamber
80 Housing part
82 Main control chamber
84 Pilot control chamber
86 Flow passage
88 Flange region
90 Main valve seat
92 Main flow duct
94 Spring element
96 Central block
98 Connecting duct
100 Pilot working chamber
102 Sliding tappet
104 Pilot housing part
106 Sealing element
108 Valve spring element
110 Pre-load element
112 Pilot spring element
118 Clearance
120 Pre-load spring
122 Pre-load washer
124 Compensation ring
126 Spring washer

1. A damping valve device for a vibration damper of a motor vehicle, comprising:
a main valve with a main piston which mutually separates a main control chamber and a pilot control chamber;
wherein the main control chamber and the pilot control chamber are fluidically connected to one another via a flow passage;
wherein the damping valve device has a spring element which is disposed and designed in such a manner that it impinges the main piston with a force acting in the closing direction of the main valve;
wherein the damping valve device has a sealing element which is designed and disposed in such a manner that it seals the main piston in relation to a housing part of the main valve;
wherein the damping valve device has a pre-load element which is designed and disposed in such a manner that it impinges the sealing element with a force acting in the axial direction of the damping valve device.

2. The damping valve device according to claim 1, wherein the pre-load element rests on the spring element.

3. The damping valve device according to claim 1, wherein the spring element comprises at least one spring washer and a compensation ring and wherein the pre-load element rests on the compensation ring.

4. The damping valve device according to claim 1, wherein the pre-load element comprises a pre-load spring.

5. The damping valve device according to claim 4, wherein the pre-load element comprises a pre-load washer.

6. The damping valve device according to claim 5, wherein the pre-load washer is disposed between the pre-load spring and the sealing element.

7. The damping valve device according to claim 6, wherein the pre-load washer rests on the sealing element.

8. The damping valve device according to claim 7, wherein the pre-load washer rests on the main piston and/or a stationary housing part.

9. The damping valve device according to claim 8, wherein the pre-load spring rests on the compensation ring.

10. The damping valve device according to claim 1, wherein the sealing element is formed from a dimensionally stable material.

11. The damping valve device according to claim 1, wherein a clearance is formed in the main piston, and the sealing element is disposed within the clearance.

12. The damping valve device according to claim 11, wherein the clearance is formed on a portion of the main piston with a continuously tapered external diameter, and wherein the sealing element rests at least partially on the tapered portion of the main piston.

13. The damping valve device according to claim 12, wherein the sealing element is attached so as to be movable within the clearance.

14. The damping valve device according to claim 1, further comprising:
a coil;
an axially movable armature which is at least partially disposed within the coil;
a pilot valve with a pilot working chamber and a sliding tappet which is disposed in the pilot working chamber and is movable axially by the armature; and
a connecting duct which is disposed between the pilot control chamber and the pilot working chamber and fluidically connects these to one another.

15. The damping valve device according to claim 1, further comprising:
a coil;
an axially movable armature which is at least partially disposed within the coil, wherein the armature is connected to the main piston in such a way that the former impinges the latter with a closing force.

16. A vibration damper for a motor vehicle, comprising:
an outer tube and an inner tube which is disposed coaxially with the outer tube; and
a working piston which is disposed so as to be axially movable within the inner tube and divides the interior of the inner tube into a piston rod-proximal working chamber and a piston rod-distal working chamber;
wherein the vibration damper comprises a damping valve device according to claim 1.
